(19) United States
(12) Patent Application Publication
(10) Pub. No.: US 2021/0293017 A1
(43) Pub. Date: Sep. 23, 2021

(54) INSULATION INCLUDING PHASE CHANGE MATERIALS

(71) Applicant: Owens Corning Intellectual Capital, LLC, Toledo, OH (US)

(72) Inventors: Alexander Lohse, Columbus, OH (US); David DeCarolis, Pataskala, OH (US); Toni Newsome, Pataskala, OH (US)

(21) Appl. No.: 17/207,969

(22) Filed: Mar. 22, 2021

Related U.S. Application Data
(60) Provisional application No. 62/993,351, filed on Mar. 23, 2020.

(51) Int. Cl. E04B 1/76

(52) U.S. Cl. CPC E04B 1/7666; E04B 2001/7691

(57) ABSTRACT

An insulation product demonstrating enhanced insulative properties is described herein. Generally, the insulation product comprises a fibrous insulation component and a phase change material. In certain embodiments, the phase change material may take the form of a layer disposed on a surface of the fibrous insulation component or interposed within the fibrous insulation component.

### CROSS-REFERENCE TO RELATED APPLICATION(S)

This application claims benefits and priority to U.S. Provisional Patent Application No. 62/993,351, filed on Mar. 23, 2020, the entire disclosure of which is incorporated herein by reference.

### FIELD

The general inventive concepts described herein relate to insulation and, more particularly, to building insulation with improved thermal insulation characteristics.

### BACKGROUND

Changes to building energy codes are requiring substantial increases in R-values of residential insulation. A common method for increasing R-value of an insulated space is to merely increase the thickness of insulative material (e.g., a fiberglass insulation batt) to reduce the heat transfer through the cavity (e.g., between studs in a residential wall). Such increases are constrained by two factors: 1) the defined space between the studs and interior and exterior wall materials; and 2) merely increasing the amount of insulating material often reaches a point of diminishing returns, meaning that certain higher R-values may not be practically achievable.

One potential way to reduce heat transfer through an insulative space and avoid or mitigate issues regarding diminishing returns is to introduce thermal mass by incorporation of a second complimentary insulating material into the space. However, efforts to accomplish this combination have failed in the past for a number of reasons including costs and industry acceptance.

### SUMMARY

The general inventive concepts discussed herein are based, at least in part, on materials for improving the initial insulative capacity of an occupied structure. Generally, the inventive concepts discussed herein are based on the recognition that certain phase change materials (PCMs) can serve as a source of latent heat storage which, when incorporated into existing building products, can provide additional thermal mass to provide mass-enhanced R-value benefit in a defined space. More specifically, phase change materials absorb heat as exterior temperatures rise above and release heat as exterior air temperatures fall below the PCM melting temperature. This leads to reduced heating/cooling loads, shifts in peak hour loading, and an overall reduction in energy consumption of the home.

In an exemplary embodiment, an insulation product is provided. The insulation product comprises a fibrous insulation component and a layer of phase change material.

In an exemplary embodiment, a method of producing an insulation product is provided. The method comprises the steps of: providing a fibrous insulation component, and integrating or otherwise joining the fibrous insulation component with a phase change material to form an insulation product.

In an exemplary embodiment, a method of insulating a building is disclosed. The method comprises providing a fibrous insulation material; positioning a layer of phase change material adjacent to the fibrous insulation material within a wall assembly; installing the fibrous insulation material and the phase change material in a wall assembly; wherein the phase change material is selected from a paraffin and a salt hydrate.

Numerous other aspects, advantages, and/or features of the general inventive concepts will become more readily apparent from the following detailed description of exemplary embodiments and from the accompanying drawings.

### BRIEF DESCRIPTION OF THE DRAWINGS

The general inventive concepts, as well as embodiments and advantages thereof, are described below in greater detail, by way of example, with reference to the drawings in which:

FIG. 1A is a picture showing individual sections of PCM-containing materials prior to temperature testing.

FIG. 1B is an image showing the temperature of the samples of FIG. 1A during testing.

FIG. 1C is a graph showing the results of heating the samples of FIG. 1A over time.

FIG. 2A shows the temperature profile during testing of several PCMs.

FIG. 2B shows the heat flux profile during testing of several PCMs.

FIG. 2C is a graph showing the results for the testing of several PCMs.

FIG. 3A shows a typical diurnal temperature cycle according to the test methods.

FIG. 3B is a graph showing results of heat flow for a paraffinic PCM placed at either 1 inch or 2 inches away from the top plate with R14.5 and R17.5 batt insulation.

FIG. 3C is a graph showing results for sinusoidal testing comparing R14.5 and R17.5 batt insulation and for salt hydrate PCM 2 inches from the top plate at two loadings (0.1 lb/ft² and 0.4 lb/ft²).

FIG. 3D is a graph showing a comparison of paraffinic PCM at 0.1 lb/ft², salt hydrate at 0.1 lb/ft², and salt hydrate at 0.4 lb/ft².

FIG. 4 is a bar graph showing the equivalent R-value for various tested samples.

FIG. 5A is a graph showing the dynamic thermal testing of ULF insulation material and a paraffinic PCM.

FIG. 5B shows a thermal image of ULF insulation material combined with a PCM.

FIG. 5C shows a thermal image of a fibrous insulation batt combined with a PCM.

FIG. 6A illustrates an embodiment of phase change material incorporated into an insulative space with the phase change material on a surface of conventional insulation.

FIG. 6B illustrates an embodiment of phase change material incorporated into an insulative space with the phase change material on a surface of conventional insulation and a wall stud or other structural member.

FIG. 6C illustrates an embodiment of phase change material incorporated into an insulative space with the phase change material on a surface of a wall stud or other structural member.

FIG. 6D illustrates an embodiment of phase change material incorporated into an insulative space with the phase change material provided within the conventional insulation (e.g., glass fiber insulation).

### DETAILED DESCRIPTION

Several illustrative embodiments will be described in detail to provide a better understanding of the invention. While the general inventive concepts contemplate combinations of phase change materials (PCMs) with a variety of insulation types, the foregoing discussion will focus mainly on the combination of fibrous insulation batts with PCMs.

The term “insulation product,” “conventional insulation material,” and “fibrous insulation material” are used interchangeably herein and refer to an insulation material that may be loose (e.g., unbonded loose fill insulation) or take the form of mat or batt made up of a backing (often Kraft paper) and substantially randomly oriented fibers that are adhered to one another by a binder. In certain exemplary embodiments, the insulation product also comprises a secondary material to aid in insulation, such as a phase change material. A variety of fibers may be used in the insulation products described herein, including, for example, glass fibers. The term “fibrous insulation component” refers to the portion of a fibrous insulation product made up of a collection of fibers. In certain embodiments, the fibers take the form of a batt bound together by a binder. In certain embodiments, the fibrous insulation component takes the form of loose nodules of unbonded insulation fibers that are often applied to an insulation cavity by blowing, otherwise referred to as loose fill insulation (or unbonded loose fill (ULF)).

The term “mass-enhanced R-value benefit” refers to an increase in the insulative capacity (R-value) of an insulation product over what a corresponding (e.g., conventional fibrous insulation material) insulation material or fibrous insulation component would achieve alone. In certain exemplary embodiments, the combination of a fibrous insulation component and a phase change material provides a mass-enhanced R-value benefit over conventional fibrous insulation.

Building codes are changing, specifically in the southwest United States, to more stringent R-value requirements. The code change will require builders to move to 2×6 construction from 2×4, incurring significant cost increases in time, material, and design. Therefore, there exists a need for insulation that can deliver an effective R-20 for a 2×4 cavity, as this could allow builders to avoid the costly transition to 2×6 construction.

The general inventive concepts contemplate an insulation product comprising a fibrous insulation component in combination with a PCM. In general, a PCM is a substance with a high heat of fusion which, melting and solidifying at a certain temperature, is capable of storing and releasing relatively large amounts of energy. A PCM absorbs heat by melting at a particular temperature, effectively storing the energy, which can later be released when the ambient temperature falls below a particular temperature. Importantly, the PCM absorbs heat, without experiencing a corresponding change in its temperature, until all of the material has changed phase (latent heat). Within occupied structures, heating and air conditioning serve to maintain constant interior temperatures as the exterior temperatures fluctuate throughout the day and night. As the exterior temperature rises, the PCM absorbs heat to undergo melting. Conversely, as the temperature drops at night below the freezing temperature the latent heat is released, again delaying and reducing the interior temperature fluctuation. This process contributes to reduced fluctuations of the interior air temperatures which subsequently reduces heating and cooling requirements.

Accordingly, the overall effect is that insulation (e.g., fiberglass insulation) including a PCM can better retain heat than fiberglass alone—smoothing rapid temperature changes (e.g., temperature drops at night and temperature increases during the day) and reducing energy consumption for heating/AC. Accordingly, PCMs are also referred to as latent heat storage materials. The most commonly used PCMs are salt hydrates, fatty acids and esters, various paraffins, and ionic liquids.

With this background in mind, the general inventive concepts seek to overcome the limitations of conventional fibrous insulation products through inclusion of a phase change material (PCM) in an insulation product, such as an insulation batt. The general inventive concepts are directed to the discovery that inclusion of a PCM can provide a source of thermal mass to increase the effective R-value (i.e., insulative capacity) of the insulation product.

Accordingly, the general inventive concepts relate to insulation products, including insulation batts and blown insulation (e.g., ULF). In an exemplary embodiment, an insulation product is provided. In an exemplary embodiment, the insulation product comprises a fibrous insulation component and a phase change material. In certain embodiments, the fibrous insulation component is in the form of a batt of substantially randomly oriented fibers gathered together by means of a binder. In certain embodiments, the fibrous material is adhered to a backing forming the batt and having a first major surface, a second major surface, and a thickness. In certain embodiments, the fibrous material is formed into a batt (without a backing material) and having a first major surface, a second major surface, and a thickness. In certain embodiments, the fibrous insulation is in the form of blown insulation. In certain exemplary embodiments, the insulation product includes a layer of a phase change material on at least one major surface of the fibrous insulation. In certain exemplary embodiments, the insulation product includes a layer of a phase change material interposed within the thickness of the fibrous insulation component. In certain exemplary embodiments, the fibrous insulation is fiberglass insulation. In certain exemplary embodiments, the layer of phase change material is a continuous layer. In certain exemplary embodiments, the layer of phase change material is a discontinuous layer. In certain exemplary embodiments, when the insulation component is a blown insulation, the PCM may be incorporated as a single layer, for example on the exterior wall or netting or within the insulation cavity, or homogeneously dispersed in the ULF (e.g., by spraying). In some cases, the PCM can be a single continuous layer when the insulation component is a batt product. In some cases, the PCM layer only covers the studs or structural members when a batt in installed. In certain exemplary embodiments, the phase change material is a paraffinic PCM. In certain exemplary embodiments, the phase change material is a fatty acid or bio-based PCM. In certain exemplary embodiments, the phase change material is a salt hydrate PCM.

Phase change materials for use in the insulation products according to the general inventive concepts preferably have a phase transition at a temperature between about 0° C. and about 40° C. In certain exemplary embodiments, the PCM has a transition temperature of about 5° C. to about 40° C. In certain exemplary embodiments, the PCM has a transition temperature of about 10° C. to about 40° C. In certain exemplary embodiments, the PCM has a transition temperature of about 15° C. to about 40° C. In certain exemplary embodiments, the PCM has a transition temperature of about 15° C. to about 35° C. Phase change materials for use in the insulation products according to the general inventive concepts preferably have a phase transition at a temperature between about 15° C. and about 30° C. The phase change experienced by the PCM depends upon the specific PCM employed, but can be fusion or crystallization, or another type of phase change, such as eutectic melting or transitions between solid phases. Preferably, the phase change does not result in a substantial volume change, as in the case of vaporization. Preferably, the PCM is a chemically inert material, or a material with limited chemical reactivity.

As previously discussed, incorporation of a PCM or combination of a PCM with a fibrous insulation component is expected to provide a mass-enhanced R-value benefit to the insulation product. In certain exemplary embodiments, the PCM is incorporated into an insulation product (e.g., fibrous insulation component such as conventional fiberglass insulation) by spraying coating or otherwise. In certain exemplary embodiments, the PCM is incorporated into an insulation product by means of spraying with a binder. In certain exemplary embodiments, the PCM is included or otherwise incorporated into the insulation production in an amount of 1% to 90% by weight of the total insulation material. In certain exemplary embodiments, the PCM is included or otherwise incorporated into the insulation production in an amount of 1% to 80% by weight of the total insulation material. In certain exemplary embodiments, the PCM is included or otherwise incorporated into the insulation production in an amount of 1% to 70% by weight of the total insulation material. In certain exemplary embodiments, the PCM is included or otherwise incorporated into the insulation production in an amount of 1% to 60% by weight of the total insulation material. In certain exemplary embodiments, the PCM is included or otherwise incorporated into the insulation production in an amount of 1% to 50% by weight of the total insulation material. In certain exemplary embodiments, the PCM is included or otherwise incorporated into the insulation production in an amount of 1% to 40% by weight of the total insulation material. In certain exemplary embodiments, the PCM is included or otherwise incorporated into the insulation production in an amount of 1% to 30% by weight of the total insulation material. In certain exemplary embodiments, the PCM is included or otherwise incorporated into the insulation production in an amount of 1% to 20% by weight of the total insulation material. In certain exemplary embodiments, the PCM is included or otherwise incorporated into the insulation production in an amount of 1% to 15% by weight of the total insulation material. In certain exemplary embodiments, the PCM is included or otherwise incorporated into the insulation production in an amount of 5% to 90% by weight of the total insulation material. In certain exemplary embodiments, the PCM is included or otherwise incorporated into the insulation production in an amount of 10% to 90% by weight of the total insulation material. In certain exemplary embodiments, the PCM is included or otherwise incorporated into the insulation production in an amount of 15% to 90% by weight of the total insulation material. In certain exemplary embodiments, the PCM is included or otherwise incorporated into the insulation production in an amount of 15% to 80% by weight of the total insulation material. In certain exemplary embodiments, the PCM is included or otherwise incorporated into the insulation production in an amount of 15% to 70% by weight of the total insulation material. In certain exemplary embodiments, the PCM is included or otherwise incorporated into the insulation production in an amount of 15% to 60% by weight of the total insulation material. In certain exemplary embodiments, the PCM is included or otherwise incorporated into the insulation production in an amount of 15% to 50% by weight of the total insulation material. In certain exemplary embodiments, the PCM is included or otherwise incorporated into the insulation production in an amount of 15% to 40% by weight of the total insulation material. In certain exemplary embodiments, the PCM is included or otherwise incorporated into the insulation production in an amount of 15% to 30% by weight of the total insulation material. In certain exemplary embodiments, the PCM is included or otherwise incorporated into the insulation production in an amount of 15% to 20% by weight of the total insulation material.

In certain exemplary embodiments, the PCM forms a layer within the insulation product, the layer having an amount of PCM of between 0.05 lb/ft² to 1 lb/ft². In certain exemplary embodiments, the PCM forms a layer within the insulation product, the layer having an amount of PCM of between 0.06 lb/ft² to 1 lb/ft². In certain exemplary embodiments, the PCM forms a layer within the insulation product, the layer having an amount of PCM of between 0.07 lb/ft² to 1 lb/ft². In certain exemplary embodiments, the PCM forms a layer within the insulation product, the layer having an amount of PCM of between 0.08 lb/ft² to 1 lb/ft². In certain exemplary embodiments, the PCM forms a layer within the insulation product, the layer having an amount of PCM of between 0.09 lb/ft² to 1 lb/ft². In certain exemplary embodiments, the PCM forms a layer within the insulation product, the layer having an amount of PCM of between 0.1 lb/ft² to 1 lb/ft². In certain exemplary embodiments, the PCM forms a layer within the insulation product, the layer having an amount of PCM of between 0.2 lb/ft² to 1 lb/ft². In certain exemplary embodiments, the PCM forms a layer within the insulation product, the layer having an amount of PCM of between 0.25 lb/ft² to 1 lb/ft². In certain exemplary embodiments, the PCM forms a layer within the insulation product, the layer having an amount of PCM of between 0.3 lb/ft² to 1 lb/ft². In certain exemplary embodiments, the PCM forms a layer within the insulation product, the layer having an amount of PCM of between 0.35 lb/ft² to 1 lb/ft². In certain exemplary embodiments, the PCM forms a layer within the insulation product, the layer having an amount of PCM of between 0.4 lb/ft² to 1 lb/ft². In certain exemplary embodiments, the PCM forms a layer within the insulation product, the layer having an amount of PCM of between 0.5 lb/ft² to 1 lb/ft². In certain exemplary embodiments, the PCM forms a layer within the insulation product, the layer having an amount of PCM of between 0.05 lb/ft² to 0.9 lb/ft². In certain exemplary embodiments, the PCM forms a layer within the insulation product, the layer having an amount of PCM of between 0.05 lb/ft² to 0.8 lb/ft². In certain exemplary embodiments, the PCM forms a layer within the insulation product, the layer having an amount of PCM of between 0.05 lb/ft² to 0.7 lb/ft². In certain exemplary embodiments, the PCM forms a layer within the insulation product, the layer having an amount of PCM of between 0.05 lb/ft² to 0.6 lb/ft². In certain exemplary embodiments, the PCM forms a layer within the insulation product, the layer having an amount of PCM of between 0.05 lb/ft² to 0.5 lb/ft².In certain exemplary embodiments, the PCM forms a layer within the insulation product, the layer having an amount of PCM of between 0.1 lb/ft² to 0.5 lb/ft².

There are a variety of PCMs that can be employed in the insulation products and still fall within the general inventive concepts. In certain embodiments, the PCM is an organic phase change material. In certain embodiments, the PCM is an inorganic phase change material. In certain embodiments, the PCM is a salt hydrate. In certain exemplary embodiments, the PCM is a fatty acid. In certain embodiments, the PCM is a paraffin. Those of skill in the art will readily understand that a variety of possible arrangements exist wherein the PCM and the insulation material are used in combination with one another. In certain exemplary embodiments, the insulation product comprises a discontinuous line or portion of PCM in contact with the insulation material. In certain exemplary embodiments, the insulation product comprises a continuous layer or portion of PCM in contact with the insulation material. In certain exemplary embodiments, the insulation product comprises a discontinuous layer of PCM and an insulation material covering at least some of the PCM. In certain exemplary embodiments, the general inventive concepts relate to PCM applied to structural members. In certain exemplary embodiments, a layer of PCM is applied to a wall stud, including each wall stud. In certain exemplary embodiments, the PCM is applied in a discontinuous manner along a wall stud.

Use of a PCM is expected to reduce the heat transfer through insulative products under common dynamic conditions by providing additional thermal mass benefits and also provide acoustic dampening benefits. While not wishing to be bound by theory, it is believed that the latent heat storage material or PCM will act as a heat sink and/or heat source, depending on the temperature, to moderate temperature fluctuations within a structure.

In certain exemplary embodiments, the insulation has an R-value of R10-R50 prior to combination with the PCM. Another way to define the insulative capacity of a wall cavity is by R-effective (R′), discussed in greater detail below. In certain exemplary embodiments, the PCM has an R′ of 1-10 (as measured through diurnal testing and analysis). In certain exemplary embodiments, an insulation material comprising a PCM and a conventional insulation material (e.g., fiberglass insulation) provide a R-value and/or R-effective (R′) that is substantially above that of the corresponding amount of conventional insulation material. In certain exemplary embodiments, incorporation of a PCM increases the R-value of a conventional insulation material by several BTU/ft²-h (e.g., incorporation of 0.1 lb/ft² increases an unaltered fibrous insulation component with an R-value of 15 to better than 19, e.g., the PCM provides a mass-enhanced R-value benefit to the insulation product).

The general inventive concepts contemplate a method of insulating a building wall cavity. In an exemplary embodiment, a method of insulating a building comprises providing a fibrous insulation batt; combining a layer of phase change material with the fibrous insulation batt within a wall cavity; wherein the phase change material is selected from a paraffin or a salt hydrate. The general inventive concepts also contemplate upgrading existing wall insulation through inclusion of a PCM. For example, an existing wall cavity may be insulated by a conventional fibrous insulation batt. The general inventive concepts contemplate addition of a PCM to the existing fibrous insulation.

### EXAMPLES

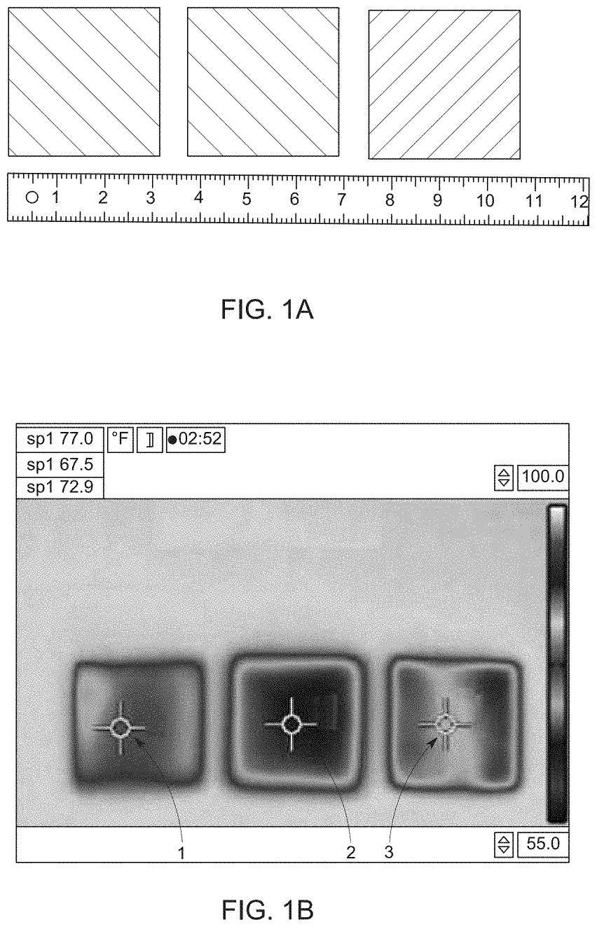

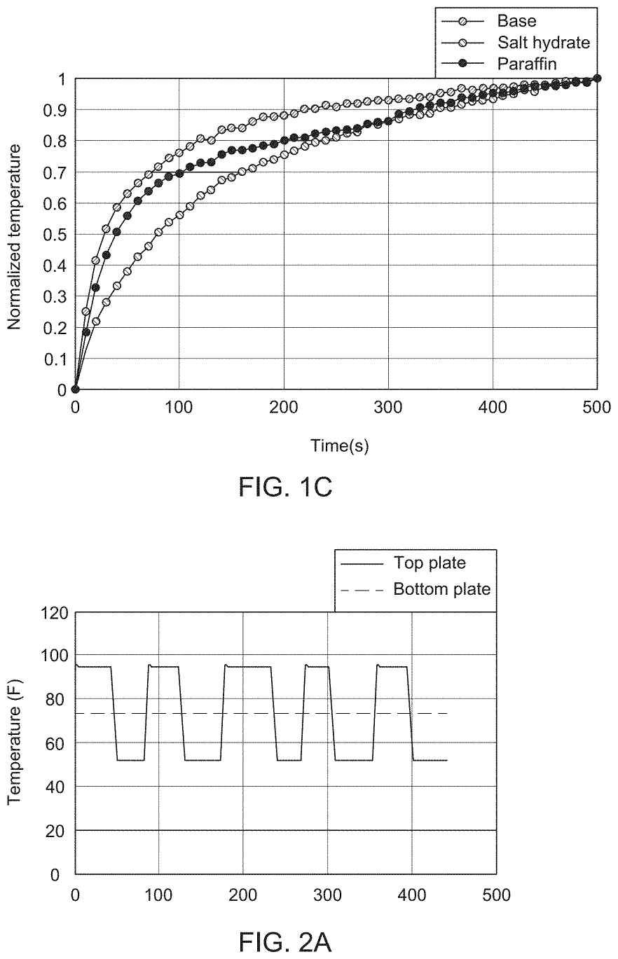

Example 1: PCMs were tested for their ability to retard heat flow. PCMs were combined with a silicone rubber binder and applied to a Kraft paper substrate. A sealing layer was applied to the top and bottom of the PCM/binder matrix to encapsulate the PCM on the Kraft paper. The layers were cast at T<T_{PCM} to prevent PCM melting during cast process by means of an aluminum plate that was chilled at 45° F. The PCMs were a salt hydrate from Insolcorp with a 22° C. melting temperature (e.g., transition temperature) and a paraffin from Microtek with a 24° C. melting temperature. The PCM was loaded at a rate of 0.1 lb/ft² (7.75 BTU/ft² paraffin and 9.5 BTU/ft² salt hydrate) with the PCM making up 25% by weight. The sealing layer was applied at thickness of 10 mils (0.25 mm) and the PCM+binder had a thickness of 55 mils (1.4 mm). A baseline measurement was recorded for a control of Kraft paper+binder alone. FIG. 1A shows the individual sections of material prior to testing. FIG. 1B is a picture showing the temperature of the samples during testing. FIG. 1C shows the results of heating the three samples over time.

Example 2: Temperature Step Change. Lasercomp Fox Heat Flow Meter Test Apparatus. Initial testing was performed using step change temperature through the phase change, not gradual sinusoidal temperature change. Tests were as follows:

TABLE 1

| Top Plate | Bottom Plate | |
|---|---|---|
| Temperature (F.) | Temperature (F.) | Criteria |
| 95 | 73.4 | Hold until |
| | | equilibration |
| 51.8 | 73.4 | Hold until |
| | | equilibration |

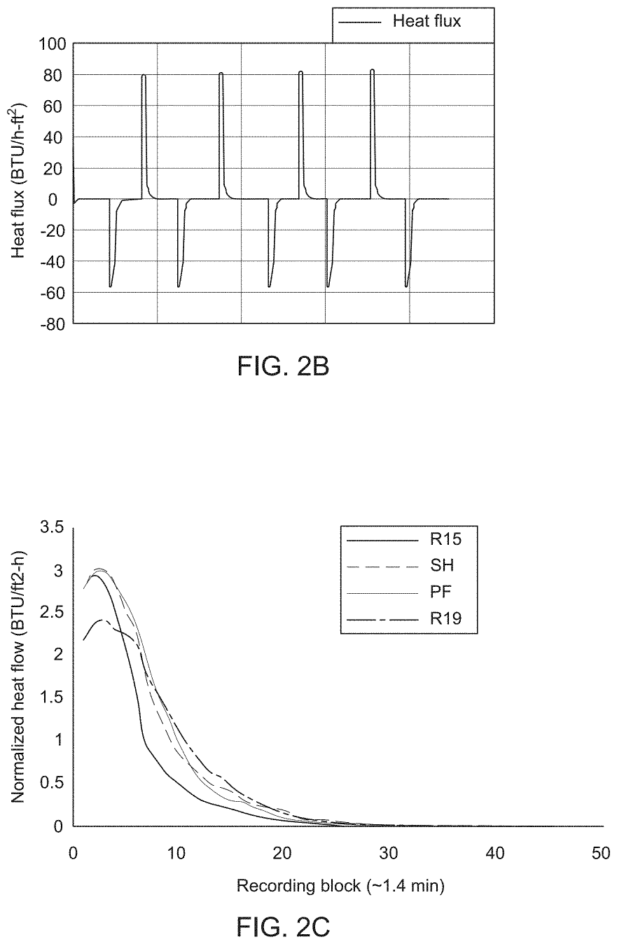

During testing, a fiberglass insulation batt having a predetermined R-value (R-15 or R-19) was placed on the bottom plate of the heat flow meter. The PCM layer was placed above the insulation batt and the top plate of the heat flow apparatus was brought into contact with the PCM layer. FIG. 2A shows the temperature profile during testing. FIG. 2B shows the heat flux profile. Table 2 shows the heat flux required to achieve steady state temperature for the samples and the corresponding controls (i.e., insulation batts by themselves). During testing, heat flux is measured across the static plate and heat flow is normalized by subtracting out steady state heat flow. Temperatures of 95° F. to 73.4° F. were measured through the plate at 73.4° F.

FIG. 2C is a graph showing the results for the testing. PCM samples require more heat flow to reach steady state conditions than R15 and R19 and exhibit peak shifting, as seen by their curve shift to longer times. Stated another way: the samples combining a fibrous insulation component and a PCM retard heat flow more than the base R15 and even above that of the base R19 sample of fibrous insulation material.

TABLE 2

| | Total Heat Flux to |
|---|---|
| | reach Steady State |
| Sample | (BTU/ft²-h) |
| R15 | 19.7 |
| R15 + Salt Hydrate | 25.7 |
| PCM (SH) | |
| R15 + Paraffin PCM | 25.9 |
| (PF) | |
| R19 | 24.5 |

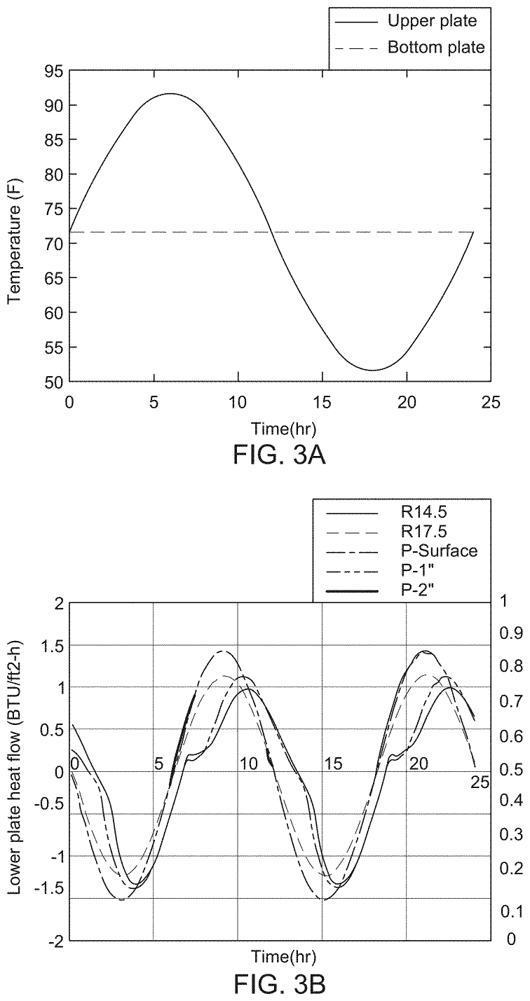

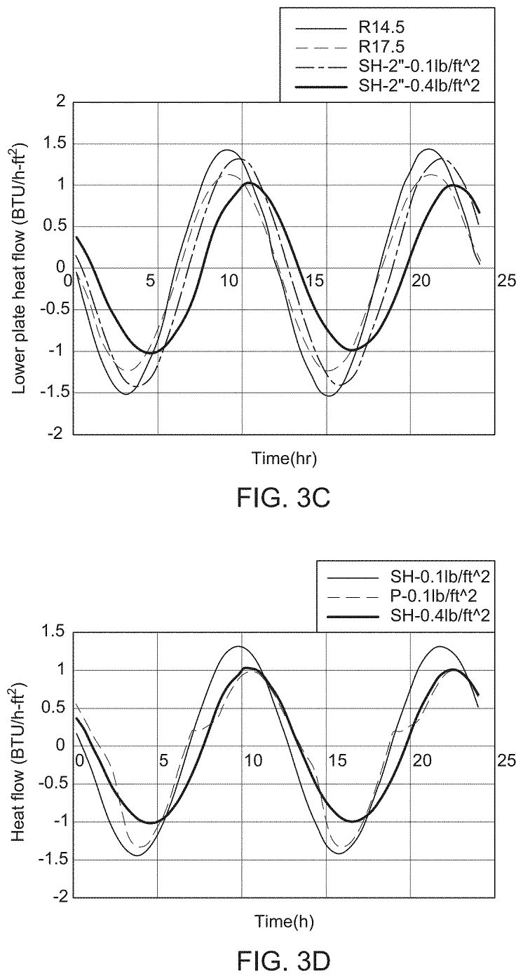

Example 3: Sinusoidal dynamic testing. In this test, one plate temperature is held constant and the opposing plate fluctuates in temperature to mimic day to night (diurnal) air temperature fluctuations. Because the properties of PCM are dynamic; this test captures PCM properties where a standard (static) ASTM C518 test might not. For this test, a layer of batt insulation was placed on a bottom plate with PCM+binder placed above the batt insulation and below the top plate. FIG. 3A shows a typical diurnal temperature cycle according to the test methods. The temperature ranges between 95° F. and 51.8° F. on the variable plate with the static temperature plate resting at 73.4° F.

FIG. 3B shows the results of heat flow for a paraffinic PCM placed either 1 inch or 2 inches away from the top plate with R14.5 and R17.5 batt insulation. FIG. 3C shows results for sinusoidal testing comparing R14.5 and R17.5 batt insulation and for a salt hydrate PCM placed 2 inches from the top plate at two loadings (0.1 lb/ft² and 0.4 lb/ft²). FIG. 3D shows a comparison of paraffinic PCM at 0.1 lb/ft², salt hydrate at 0.1 lb/ft², and salt hydrate at 0.4 lb/ft². The paraffin and salt hydrate samples were tested at 2 inches below the top plate. As can be seen from the graphs, salt hydrates do not exhibit the characteristic phase change transition zone seen with paraffins. Salt hydrates show similar reduction in heat flow as paraffins, although at higher loading.

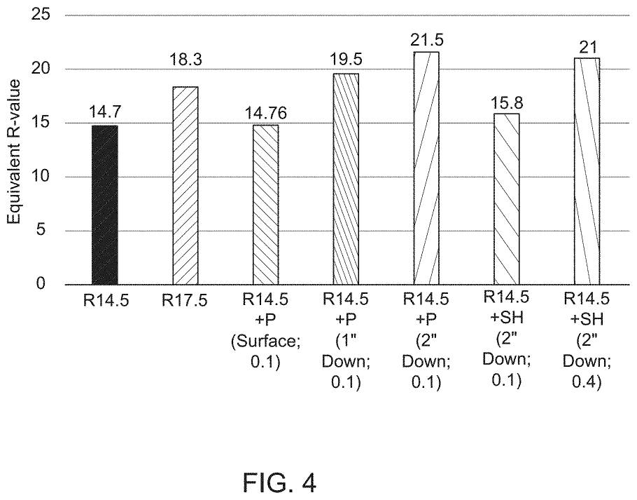

FIG. 4 is a bar graph showing the equivalent R-value for various tested samples. Two different dynamic test methods were used to show the benefit of PCMs over base fiberglass. Both paraffin and salt hydrate exhibited +R′-21 or more at ˜2.5″ from top plate—paraffin at 0.1 lb/ft² and salt hydrate at 0.4 lb/ft² loadings.

In this testing, equivalent R-value was used as a key metric to characterize performance of the samples containing phase change material. Similar to the dynamic mass benefit R-value used in the masonry and concrete industry, the equivalent R-value defined here has no physical meaning, but represents the performance improvement for a product enhanced with PCM. The key principle is relating the total heat flow over the course of the sinusoidal testing to a fictitious, lightweight, fibrous insulation (Base) experiencing the same test,

Qₜ^{Base}=Qₜ^{PCM}

The total heat flow is defined as the integral of heat flux over time,

∫₀^{t}^{_{Total}}|q^{Base}|dt=∫₀^{t}^{_{Total}}|q^{PCM}|dt

For the base material, heat flux is the change in temperature over R-value, (this is the steady state equation, but the approximation holds for long test periods seen here and for lightweight, fibrous materials), which gives

$$\frac{1}{{R}^{′}} {\int }_{0}^{{t}_{Total}} A \vert sin ( \frac{2 π t}{{t}_{Total}} ) \vert dt = {\int }_{0}^{{t}_{Total}} \vert {q}^{PCM} \vert dt$$

Where A is amplitude of oscillation, t is time, and tₜₒₜₐₗ is the total test time. By relating the heat flow through the fibrous insulation layer with PCM, to the Base material (fictitious fibrous insulation material without PCM) we obtain an equivalent R-value, or the true R-value of a fibrous insulation material that would be required to give the same heat flux as a fibrous insulation product containing PCM.

$${R}^{′} = \frac{{\int }_{0}^{{t}_{T o t a l}} A \vert sin ( \frac{2 π t}{{t}_{Total}} ) \vert dt}{{\int }_{0}^{{t}_{Total}} \vert {q}^{PCM} \vert dt}$$

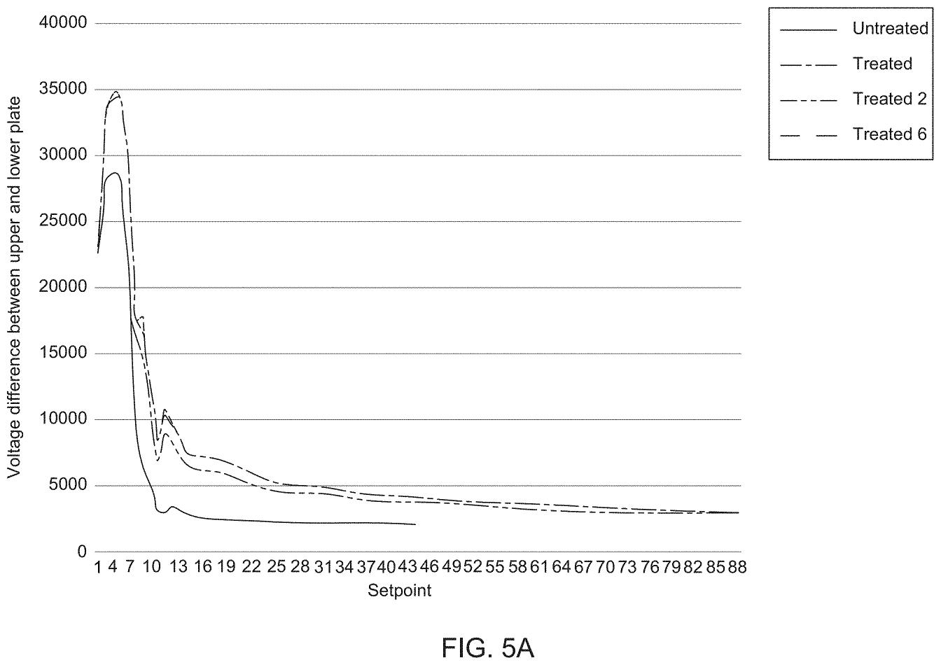

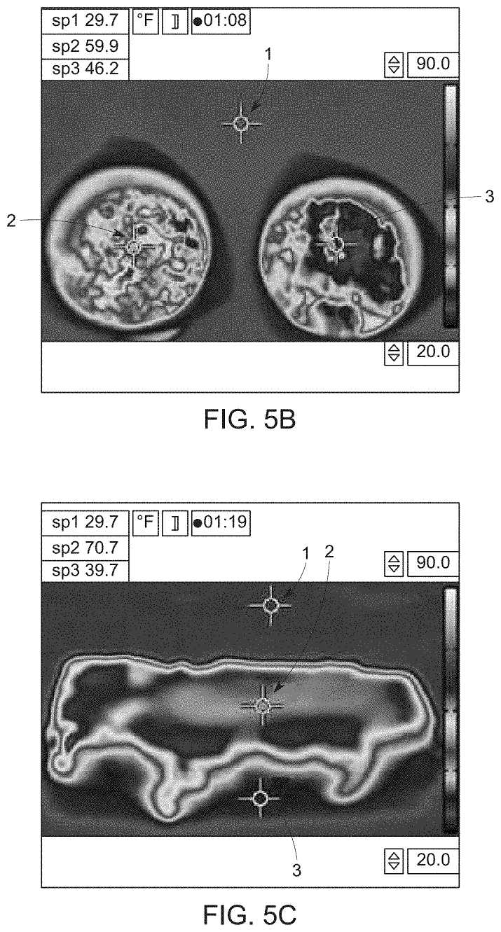

Example 4: Thermal testing of PCM. The PCM (Microtek nextek paraffinic PCMs) was sprayed onto ULF using a gravity fed sprayer with final weight percentages at 16.67% PCM, 16.67% binder, and 66.67% ULF. Dynamic thermal testing was performed. Temperature was stabilized at 75° F. and the plates were changed to 55° F. and 95° F. Heat transfer between the plates (voltage difference) was measured. “Treated” samples are PCM/ULF, “untreated” sample is nominal ULF. FIG. 5A shows higher required voltage seen in the treated samples indicates higher thermal mass compared to nominal ULF.

FIGS. 5B and 5C show thermal images of PCM blown on ULF (5B) and a PCM layer on a fiberglass batt (5C). The samples were heated in an oven at ˜110° F. and pulled from the oven and placed in ˜30° F. ambient air. Testing demonstrates the PCM ability to maintain their temperature for a time period exceeding that of standard fibrous insulation. In FIG. 5B, point 1 is ambient, point 2 is a ULF sample with PCM, point 3 is standard ULF. In FIG. 5C, point 1 is ambient, point 2 is a PCM layer on top of a batt sample, and point 3 is the batt.

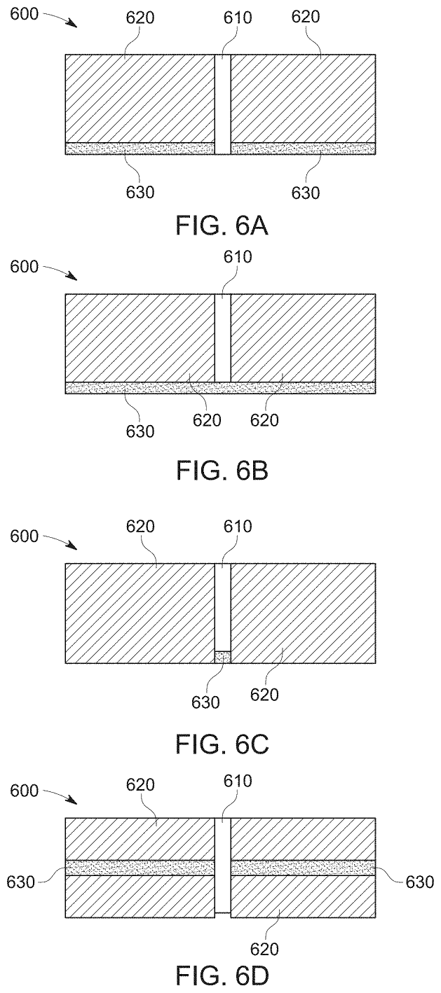

FIG. 6A illustrates an embodiment of phase change material incorporated into an insulative space with the phase change material on a surface of conventional insulation. The assembly 600 includes a structural member 610 (e.g., a wall stud) with conventional insultation 620 (e.g., glass fiber insulation) positioned in the insulative space. A layer of phase change material 630 is shown on a surface of the conventional insulation material. While the phase change material is shown as a discrete layer, those of ordinary skill in the art will recognize that the phase change material may be incorporated in other arrangements and installation means and may be incorporated onto a surface of conventional insulation as e.g., a discontinuous spray or otherwise embedded into the conventional insulation and still fall within the general inventive concepts. The general inventive concepts encompass embodiments wherein the phase change material is present on an exterior facing side of the insulative space (e.g., the side that faces an exterior cladding or wall) or the interior facing side, or both.

FIG. 6B illustrates an embodiment of phase change material incorporated into an insulative space with the phase change material on a surface of conventional insulation and a wall stud or other structural member. The assembly 600 includes a structural member 610 (e.g., a wall stud) with conventional insultation 620 (e.g., glass fiber insulation) positioned in the insulative space. A layer of phase change material 630 is shown on a surface of the structural member but not on the conventional insulation material.

FIG. 6C illustrates an embodiment of phase change material incorporated into an insulative space with the phase change material on a surface of a wall stud or other structural member. The assembly 600 includes a structural member 610 (e.g., a wall stud) with conventional insultation 620 (e.g., glass fiber insulation) positioned in the insulative space. A layer of phase change material 630 is shown on a surface of the both the structural member and the conventional insulation material. In certain embodiments, the phase change material may be positioned along an entire length of a wall assembly or only a portion of the wall assembly (e.g., if a wall assembly includes both sections that are exterior facing and those that are fully enclosed in the building space, then the phase change material may be incorporated only in those portions of the wall that are exposed to the exterior).

FIG. 6D illustrates an embodiment of phase change material incorporated into an insulative space with the phase change material provided within the conventional insulation (e.g., glass fiber insulation). As previously mentioned, while the phase change material is shown as a discrete layer within the conventional insulation, those of ordinary skill in the art will recognize that the phase change material may be incorporated in other arrangements and installation means and may be incorporated into the conventional insulation as e.g., a discontinuous spray or otherwise embedded into the conventional insulation or may be incorporated in more than one layer or portion of the conventional insulation and still fall within the general inventive concepts.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The insulation products and corresponding manufacturing methods of the present disclosure can comprise, consist of, or consist essentially of the essential elements and limitations of the disclosure as described herein, as well as any additional or optional components, or limitations described herein or otherwise useful in fiber-reinforced composite materials.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another (e.g., one or more of the exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described.

1. An insulation product comprising:
a fibrous insulation component made up of a plurality of randomly oriented fibers; and
a phase change material having a transition temperature of from 0° C. to 40° C. in an amount of 1% to 90% by weight of the insulation product.

2. The insulation product of claim 1, wherein the phase change material is a continuous layer.

3. The insulation product of claim 1, wherein the phase change material is a discontinuous layer.

4. The insulation product of claim 4, wherein the phase change material is present in an amount of 0.05 lb/ft² to 1 lb/ft².

5. The insulation product of claim 1, wherein the phase change material is disposed on a first major surface of the fibrous insulation component.

6. The insulation product of claim 1, wherein the phase change material is disposed between a first major surface and a second major surface of the fibrous insulation component.

7. The insulation product of claim 1, wherein the fibers are glass fibers.

8. The insulation product of claim 1, wherein the phase change material has a transition temperature of from 15° C. to 30° C.

9. The insulation product of claim 1, wherein the phase change material is a paraffin.

10. The insulation product of claim 1, wherein the phase change material is a salt hydrate.

11. A method of producing an insulation product, the method comprising:
providing a fibrous insulation component made up of a plurality of fibers, and contacting the fibrous insulation component with a phase change material to form an insulation product, wherein the phase change material is present in an amount of 1% to 90% by weight of the insulation product.

12. The method of claim 11, wherein the phase change material forms a continuous layer on a surface of the fibrous insulation component.

13. The method of claim 11, wherein the phase change material forms a discontinuous layer on a surface of the fibrous insulation component.

14. The method of claim 11, wherein the phase change material is disposed within the fibrous insulation component.

15. The method of claim 11, wherein the fibers are glass fibers.

16. The method of claim 11, wherein the phase change material has a transition temperature of from 0° C. to 40° C.

17. The method of claim 11, wherein the phase change material is a paraffin.

18. The method of claim 11, wherein the phase change material is a salt hydrate.

19. A method of insulating a building, the method comprising:
providing a fibrous insulation material;
positioning a phase change material adjacent to the fibrous insulation material within a wall assembly;
installing the fibrous insulation material with the phase change material in a wall assembly;
wherein the phase change material is selected from a paraffin and a salt hydrate.

20. The method of claim 19, wherein the layer of phase change material is positioned on a structural member.
